(19) United States
(12) Patent Application Publication
(10) Pub. No.: US 2025/0013826 A1
(43) Pub. Date: Jan. 9, 2025

(54) DEVICE AND METHOD FOR GENERATING EMOTION-CAUSE PAIR BASED ON CONVERSATION, AND STORAGE MEDIUM STORING INSTRUCTION TO PERFORM METHOD FOR GENERATING EMOTION CAUSE PAIR

(71) Applicant: Research & Business Foundation SUNGKYUNKWAN UNIVERSITY, Suwon-si (KR)

(72) Inventors: DongJin JEONG, Suwon-si (KR); JinYeong BAK, Suwon-si (KR); Jaehyeok LEE, Suwon-si (KR)

(73) Assignee: Research & Business Foundation SUNGKYUNKWAN UNIVERSITY, Suwon-si (KR)

(21) Appl. No.: 18/763,073

(22) Filed: Jul. 3, 2024

(30) Foreign Application Priority Data
Jul. 3, 2023 (KR) 10-2023-0086040
Jun. 3, 2024 (KR) 10-2024-0072514

(51) Int. Cl. G06F 40/284

(52) U.S. Cl. CPC G06F 40/284

(57) ABSTRACT

There is provided a method for generating an emotion cause pair based on conversation. The method comprises receiving a plurality of utterance texts converted from a voice conversation between a plurality of speakers; classifying each of the plurality of utterance texts for each emotion and detecting at least one of emotion utterance texts among the plurality of utterance texts; generating candidate emotion cause pairs each including a pair of an emotion utterance text selected from among the at least one of the emotion utterance texts and a cause utterance text corresponding to the selected emotion utterance text; and determining the emotion cause pair from the plurality of generated candidate emotion cause pairs.

### CROSS-REFERENCE TO RELATED APPLICATION

This application claims priority to Korean Patent Application No. 10-2023-0086040, filed on Jul. 3, 2023, and Korean Patent Application No. 10-2024-0072514, filed on Jun. 3, 2024 in the Korean Intellectual Property Office, the entire disclosures of which are incorporated herein by reference for all purposes.

### TECHNICAL FIELD

The present disclosure relates to a technology for extracting an emotion-cause pair, and more particularly, to a technology for extracting emotion-cause pairs from conversations between multiple speakers.

This work was partly supported by Institute for Information & communications Technology Promotion (IITP) grant funded by the Korea government (MSIT; Ministry of Science and ICT) (No. 2019-0-00421-005, Project for supporting the Graduate School of Artificial Intelligence (Sungkyunkwan University), and No. 2020-0-01821-004, Project for Training ICT Excellent Talent (Sungkyunkwan University)).

### BACKGROUND

Recently, as interest in developing human-like AI has increased, opinions are emerging that it is important to acquire an understanding of emotions. Emotion-cause pair extraction (ECPE) refers to extracting all emotions that occur in a document and their corresponding causes. The ECPE is an important task for developing human-like responses, but because the existing ECPE research was mainly conducted based on conversations and news articles with different characteristics, it is difficult to directly apply the existing research to the human-like AI.

### SUMMARY

In view of the above, the present disclosure provides a technology for extracting an emotion-cause pairs based on conversations between multiple speakers.

In addition, the present disclosure provides a technology for extracting emotion-cause pairs based on mixture-of-experts (MoE) technique.

In addition, the present disclosure provides a technology for generating emotion-cause pairs that can be used for emotion learning of conversational AI models.

In accordance with an aspect of the present disclosure, there is provided a method for generating an emotion cause pair based on conversation performed by an apparatus using an emotion cause pair prediction model, the method comprises: receiving a plurality of utterance texts converted from a voice conversation between a plurality of speakers; classifying each of the plurality of utterance texts for each emotion and detecting at least one of emotion utterance texts among the plurality of utterance texts; generating candidate emotion cause pairs each including a pair of an emotion utterance text selected from among the at least one of the emotion utterance texts and a cause utterance text corresponding to the selected emotion utterance text; and determining the emotion cause pair from the plurality of generated candidate emotion cause pairs.

Additionally, the receiving the plurality of utterance texts may include receiving utterance order information of the plurality of utterance texts, and wherein the generating the candidate emotion cause pairs may include determining the cause utterance text of the selected emotion utterance text corresponding to a present or past utterance text within a preset number of times of utterances based on the utterance order information.

Additionally, the receiving may include receiving information of the plurality of speakers corresponding to each utterance text, and the generating the emotion cause pair may include determining an emotion cause pair type based on information of each speaker and an emotion type of each speaker, and generating the emotion cause pair based on the emotion cause pair type.

Additionally, the generating the emotion cause pair may include determining at least one true emotion cause pair based on a mix-of-experts (MOE) technique using a gating network and a plurality of expert models.

Additionally, each expert model may be a model pre-trained to predict the true emotion cause pair corresponding to each emotion cause pair type, and the gating network is configured to determine a weight for a prediction result of each expert model.

Additionally, the generating the emotion cause pair may include inputting a first candidate emotion cause pair among the candidate emotion cause pairs into each expert model, and determining whether the first candidate emotion cause pair is a true emotion cause pair corresponding to any of the emotion cause pair types based on the prediction result of each expert model and the weight.

Additionally, the detecting the at least one of the emotion utterance texts may include vectorizing each utterance text including a previous utterance text based on a natural language processing model, and classifying each vectorized utterance text into at least one of several emotion based on an emotion classification model.

Additionally, the detecting the at least one of the emotion utterance texts may include generating a token sequence from the plurality of utterance texts based on a tokenizer and generating a token sequence representation from the token sequence based on BERT to generate each utterance text.

Additionally, the detecting the at least one of the emotion utterance texts may include classifying the utterance text as at least one of emotion type among a plurality of emotion types.

Additionally, the generating the plurality of candidate emotion cause pairs may include generating the candidate emotion cause pair including the selected emotion utterance text corresponding to the same emotion type among the plurality of emotion types and a present or past cause utterance text within the set number of times of utterances in the at least one of the emotion utterance texts.

In accordance with another aspect of the present disclosure, there is provided a device for generating an emotion cause pair based on conversation, the device comprises: a memory configured to store by an emotion cause pair prediction model and one or more instructions for preforming the emotion cause pair prediction model; and a processor configured to execute the one or more instructions stored in the memory, wherein the instructions, when executed by the processor, cause the processor to: receive a plurality of utterance texts converted from a voice conversation between a plurality of speakers; classify each of the plurality of utterance texts for each emotion and detect at least one of emotion utterance texts among the plurality of utterance texts; generate candidate emotion cause pairs each including a pair of an emotion utterance text selected from among the at least one of the emotion utterance text texts and a cause utterance text corresponding to the selected emotion utterance text; and determine the emotion cause pair from the plurality of generated candidate emotion cause pairs.

Additionally, the processor may be configured to receive utterance order information of the plurality of utterance texts, and determine the cause utterance text of the selected emotion utterance text corresponding to a present or past utterance text within a preset number of times of utterances based on the utterance order information.

Additionally, the processor may be configured to receive information of the plurality of speakers corresponding to each utterance text, and determine an emotion cause pair type based on information of each speaker and an emotion type of each speaker, and generating the emotion cause pair based on the emotion cause pair type.

Additionally, the processor may be configured to determine at least one true emotion cause pair based on a mix-of-experts (MOE) technique using a gating network and a plurality of expert models.

Additionally, each expert model may be a model pre-trained to predict the true emotion cause pair corresponding to each emotion cause pair type, and the gating network may be configured to determine a weight for a prediction result of each expert model.

Additionally, the processor may be configured to input a first candidate emotion cause pair among the candidate emotion cause pairs into each expert model, and determine whether the first candidate emotion cause pair is a true emotion cause pair corresponding to any of the emotion cause pair types based on the prediction result of each expert model and the weight.

Additionally, the processor may be configured to vectorize each utterance text including a previous utterance text based on a natural language processing model, and classifying each vectorized utterance text into at least one of several emotion based on an emotion classification model.

Additionally, the processor may be configured to generate a token sequence from the plurality of utterance texts based on a tokenizer, and generate a token sequence representation from the token sequence based on BERT to generate each utterance text.

Additionally, the processor may be configured to generate the candidate emotion cause pair including the selected emotion utterance text corresponding to the same emotion type among the plurality of emotion types and the cause utterance text.

In accordance with another aspect of the present disclosure, there is provided a non-transitory computer readable storage medium storing computer executable instructions, wherein the instructions, when executed by a processor, cause the processor to perform a method for generating an emotion cause pair based on conversation, the method comprise: receiving a plurality of utterance texts converted from a voice conversation between a plurality of speakers; classifying each of the plurality of utterance texts for each emotion and detecting at least one of emotion utterance texts among the plurality of utterance texts; generating candidate emotion cause pairs each including a pair of an emotion utterance text selected from among the at least one of the emotion utterance texts and a cause utterance text corresponding to the selected emotion utterance text; and determining the emotion cause pair from the plurality of generated candidate emotion cause pairs.

According to an aspect of the present disclosure, it is possible to extract the emotion-cause pairs based on the conversations between multiple speakers.

In addition, according to an aspect of the present disclosure, it is possible to extract the emotion-cause pairs based on the mixture-of-experts (MoE) technique.

In addition, according to an aspect of the present disclosure, it is possible to generate the emotion-cause pairs that can be used for the emotion learning of the conversational AI models.

### BRIEF DESCRIPTION OF THE DRAWINGS

FIG. 1 is a block diagram of an apparatus for generating an emotion cause pair according to an embodiment of the present disclosure.

FIGS. 2 to 4 are diagrams for describing an emotion cause pair prediction model according to an embodiment of the present disclosure.

FIG. 5 is a flowchart of a method for generating an emotion cause pair based on conversation according to an embodiment of the present disclosure.

FIG. 6 is a block diagram of an apparatus for generating an emotion cause pair according to another embodiment of the present disclosure.

FIGS. 7 and 8 are diagrams for describing an example of tokenizing utterance text.

### DETAILED DESCRIPTION

The advantages and features of the present invention, and the methods of achieving them, will become apparent by referring to the embodiments described in detail below in conjunction with the accompanying drawings. However, the present invention is not limited to the embodiments disclosed herein and can be implemented in various forms. These embodiments are provided to make the disclosure of the present invention thorough and to fully convey the scope of the invention to those skilled in the art, and the scope of the present invention is defined only by the claims.

In describing the embodiments of the present invention, specific descriptions of well-known functions or configurations will be omitted for clarity and conciseness where they are not essential to understanding the embodiments. The terms used herein are defined in consideration of the functions in the embodiments of the present invention and may vary depending on the user, operator's intention, or custom. Therefore, the definitions should be based on the entire content of this specification.

The present invention may be subject to various modifications and may include several embodiments, specific embodiments being illustrated in the drawings and described in detail.

However, this is not intended to limit the present invention to specific embodiments, and it should be understood to include all modifications, equivalents, and substitutes included within the spirit and scope of the present invention as defined by the appended claims.

Terms including ordinals such as first, second, etc., may be used to describe various components, but these components are not limited by such terms. These terms are used only to distinguish one component from another.

When a component is described as being “connected” or “coupled” to another component, it may be directly connected or coupled to the other component or intervening components may be present.

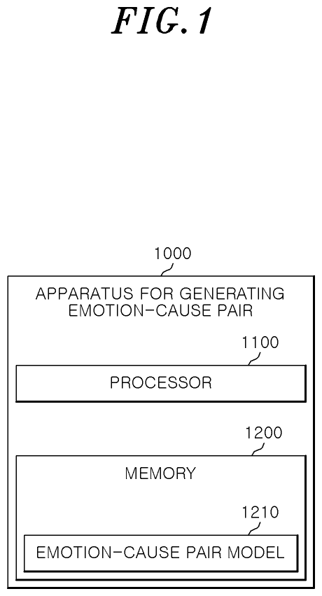

FIG. 1 is a block diagram of an apparatus 1000 for generating an emotion cause pair according to an embodiment of the present disclosure.

Referring to FIG. 1, the apparatus 1000 for generating an emotion-cause pair may include a processor 1100 and a memory 1200.

The processor 1100 may control the overall operation of the apparatus 1000 for generating an emotion-cause pair by executing instructions stored in the memory 1200 and generate an emotion-cause pair from utterance data between multiple speakers.

The memory 1200 may be executed by the processor 1100, control the overall operation of the apparatus 1000 for generating an emotion cause pair, and store instructions used to generate the emotion cause pair from the utterance data between the multiple speakers.

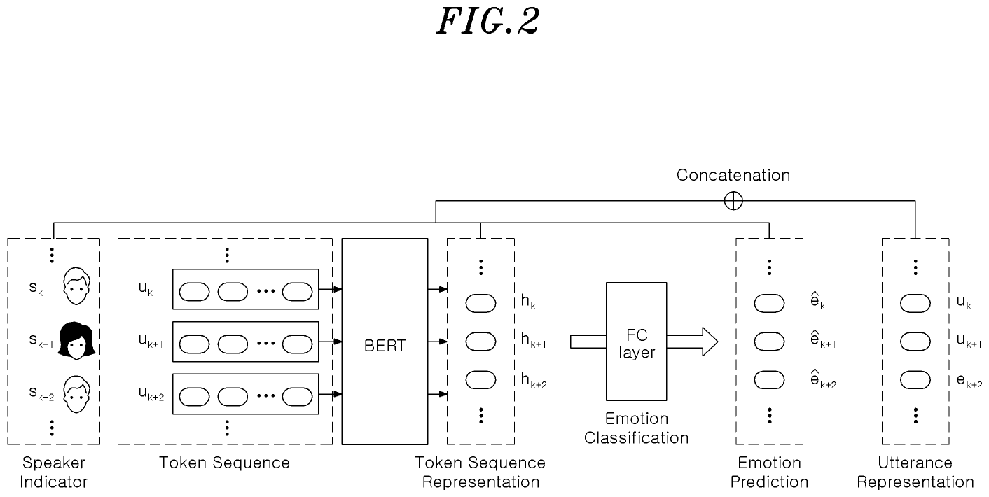

In an embodiment, the instructions stored in the memory 1200 may include an emotion cause pair prediction model 1210 composed of instructions used to generate the emotion cause pair. The emotion cause pair prediction model 1210 will be described in more detail below with reference to FIGS. 2 to 5.

FIGS. 2 to 4 are diagrams for describing an emotion cause pair prediction model according to an embodiment of the present disclosure.

Referring to FIG. 2, the process of generating an utterance representation from utterance data in the emotion cause pair prediction model 1210 is illustrated. The emotion cause pair prediction model 1210 may vectorize and tokenize a plurality of utterance texts Uₖ, Uₖ₊₁, and Uₖ₊₂ to generate token sequences. Thereafter, the emotion cause pair prediction model 1210 may input the token sequences for each of the plurality of utterance texts Uₖ, Uₖ₊₁, and Uₖ₊₂ to a BERT model to generate token sequence representations hₖ, hₖ₊₁, and hₖ₊₂. The emotion cause pair prediction model 1210 may use the token sequence representations hₖ, hₖ₊₁, and hₖ₊₂ to an emotion classification model such as a feed-forward neural network (FFNN) to classify the token sequence representations hₖ, hₖ₊₁, and hₖ₊₂ of each of the plurality of utterance texts into any one of the predetermined emotion types, thereby classifying the plurality of utterance texts into either emotion utterance text or non-emotion utterance text. The emotion cause pair prediction model 1210 may generate emotion prediction data eₖ, eₖ₊₁, and eₖ₊₂ as a result of the classification.

In an embodiment, in the process of vectorizing each of the plurality of utterance texts Uₖ, Uₖ₊₁, and Uₖ₊₂, each of the plurality of utterance texts may be generates as the token sequences by referring to the utterance text of the previous time. For example, the utterance text Uₖ₊₁ may be generated as the token sequence, further including the previous utterance text Uₖ, and the utterance text Uₖ₊₂ may be generated as the taken sequence, further including the previous utterance text Uₖ and Uₖ₊₁.

In this case, the utterance text classified as a neutral emotion may be classified as not corresponding to an emotion utterance text. The emotion cause pair prediction model 1210 may concatenate information (speaker indicator) Sₖ, Sₖ₊₁, and Sₖ₊₂, the token sequence representations hₖ, hₖ₊₁, and hₖ₊₂, and the emotion prediction data êₖ, êₖ₊₁, and êₖ₊₂ of multiple speakers, thereby generating utterance representations Uₖ, Uₖ₊₁, and Uₖ₊₂.

In an embodiment, the emotion cause pair prediction model 1210 may generate the emotion prediction data according to Equation 1 below.

$${\hat{e}}_{i} = Softmax ( {W}^{e} {H}_{i} + {b}^{e} ) \qquad [ Equation l ]$$

Here, w^{e} may refer to a weight, and be may refer to a bias of an emotion classification layer.

In an embodiment, the utterance representation may be concatenated according to Equation 2 below.

$${U}_{i} = {H}_{i} ⊕ {\hat{e}}_{i} ⊕ {S}_{i} \qquad [ Equation 2 ]$$

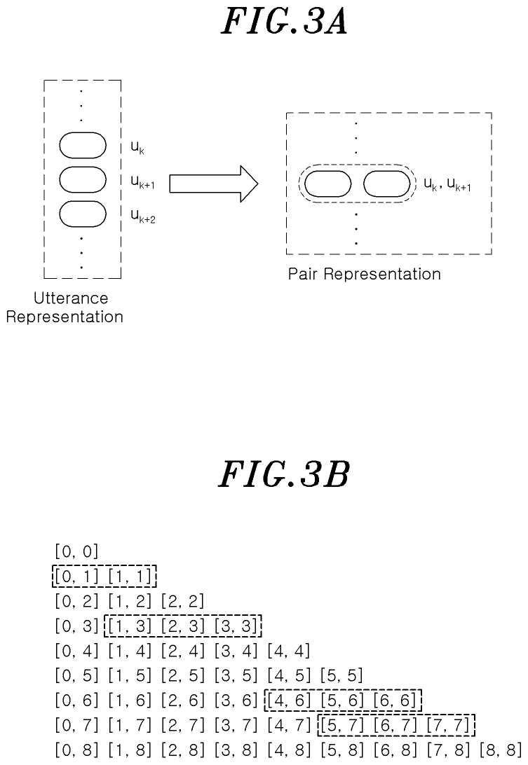

Referring to FIGS. 3A and 3B, an example of the emotion cause pair prediction model 1210 generating the candidate emotion cause pair based on the utterance representation is illustrated. In FIG. 3A, the emotion cause pair prediction model 1210 may match the utterance representations Uₖ, Uₖ₊₁, and Uₖ₊₂, that is, the utterance representation of an arbitrary emotion utterance text with an arbitrary cause utterance text to generate the plurality of candidate emotion cause pairs Uₖ, Uₖ₊₁. In FIG. 3B, the emotion cause pair prediction model 1210 may generate 45 candidate emotion cause pairs that can be generated by a combination of 9 emotion utterance texts 0, 1, . . . , 8 and an utterance text that precedes each emotion utterance text among the 9 cause utterance texts 0, 1, . . . , 8. Here, 0 to 8 may refer to utterance order information of the emotion utterance text and the cause utterance text.

In an embodiment, the emotion cause pair prediction model 1210 may generate a candidate emotion cause pair (pair candidate) based on the utterance order information. For example, the emotion cause pair prediction model 1210 may match the arbitrary emotion utterance text with the arbitrary cause utterance text to generate the candidate emotion cause pair, and match the present or past arbitrary cause utterance text within a preset number of times of utterances with the arbitrary emotion utterance text based on the utterance order information of the arbitrary emotion utterance text to generate the emotion cause pair. For example, in FIG. 3B, candidate emotion cause pairs corresponding to [0, 1], [1, 1], [1, 3], [2, 3], [3, 3], [4, 6], [5, 6], [6, 6], [5, 7], [6, 7], and [7, 7] may be generated. This is because the contents that are a cause of a specific emotion are usually included in a past utterance to which the utterance is temporally close or present utterance.

In an embodiment, the candidate emotion cause pair may be generated according to Equation 3 below.

$${x}_{ij} = {u}_{i} ⊕ {u}_{j} \qquad [ Equation 3 ]$$

Here, xᵢⱼ may refer to the candidate emotion cause pair, uᵢ may refer to the utterance representation of the emotion utterance text, and uⱼ may refer to the utterance representation of the cause utterance text.

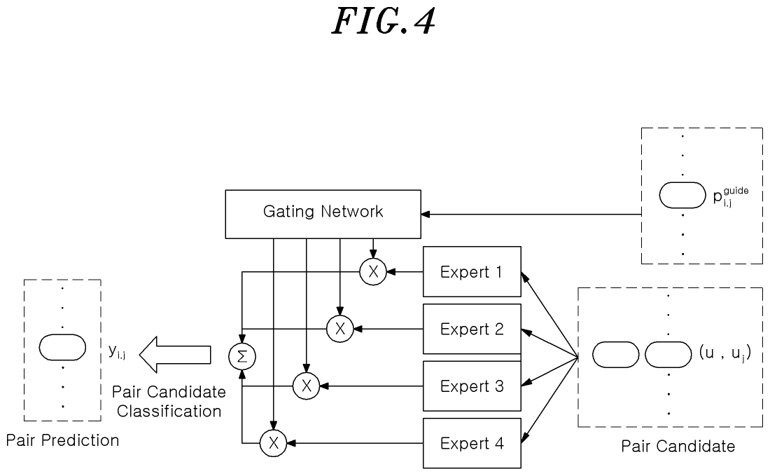

Referring to FIG. 4, an example in which the emotion cause pair prediction model 1210 determines the actual emotion cause pair among the candidate emotion cause pairs (pair representation) is illustrated. In the emotion cause pair prediction model 1210, each candidate emotion cause pair (pair representation) is input to a plurality of expert models expert 1 to expert 4. Each of the plurality of expert models expert 1 to expert 4 may output prediction results of the emotion cause pair type for any one candidate emotion cause pair. In this case, each of the plurality of expert models expert 1 to expert 4 may be pre-trained to predict different emotion cause pair types. A gating network may determine whether the candidate emotion cause pair is an actual emotion cause pair for any emotion cause pair type based on the sum of values obtained by multiplying the weights for the prediction results of each of the plurality of expert models expert 1 to expert 4 by the results of predicting each of the plurality of expert models expert 1 to expert 4. In this case, the gating network may be pre-trained to have the weights for the prediction results of each of the plurality of expert models expert 1 to expert 4. In an experimental example for the present disclosure, a RECCON dataset was used to train the gating network and the plurality of expert models.

In an embodiment, the emotion cause pair type may be classified according to whether the speaker and the emotion type are the same. Specifically, the emotion cause pair type may be classified into a case where the speaker and the emotion type are the same (case where any one speaker maintains the same emotional state during conversation), a case where the speaker is the same but the emotion type is different (case where any one speaker utters an emotion (or cause) and then utters a cause (or emotion)), a case where the speaker is different but has the same emotion type (when multiple speakers share any one emotion, i.e., sympathize), and a case where both the speaker and the emotion type are different.

In an embodiment, guide information pᵢⱼ^{guide} refers to classification information on the emotion cause pair type input to the gating network, and may be expressed as Equation 4 below.

$${p}_{ij}^{guide} = \{ \begin{matrix}[ 1 , 0 , 0 , 0 ] \\ [ 0 , 1 , 0 , 0 ] \\ [ 0 , 0 , 1 , 0 ] \\ [ 0 , 0 , 0 , 1 ]\end{matrix}$$

Here, a first row of the matrix may refer to the case where the speaker and the emotion type are the same, a second row may refer to the case where the speaker is the same but the emotion type is different, a third row may refer to the case where the speaker is different but the emotion type is the same, and a fourth row may refer to the case where the speaker and the emotion type are the same.

In an embodiment, the weights for the prediction results of each expert model may be determined according to Equation 4 below.

$${p}_{ij} = ( 1 - λ ) \times {g}_{θ} ( {x}_{ij} ) + λ \times {p}_{ij}^{guide} \qquad [ Equation 4 ]$$

Here, pᵢⱼ and xᵢⱼ may refer to the candidate emotion cause pair and the weights of each expert model, and g_{θ}(xᵢⱼ) may refer to a function of the gating network.

$${y}_{ij} = {\sum }_{n = 1}^{k} {p}_{ij}^{n} {f}_{θ}^{n} ( {x}_{ij} ) \qquad [ Equation 5 ]$$

Here, yᵢⱼ may represent the output of the emotion cause pair prediction model 1210, that is, the result of determining whether each of the plurality of candidate emotion cause pairs is the actual emotion cause pair, and f_{θ}ⁿ(xᵢⱼ) may represent an output of an nth expert model.

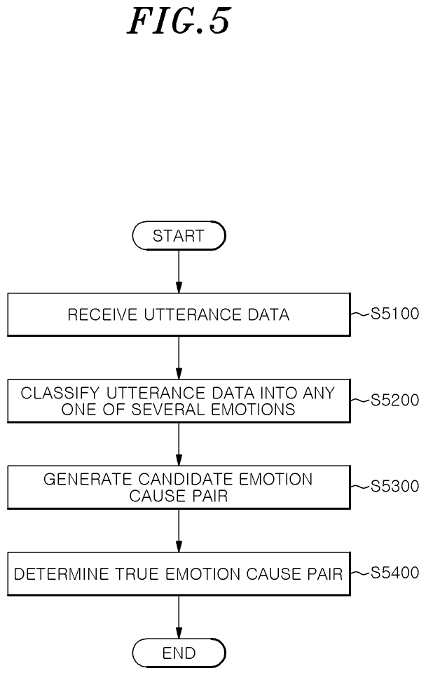

FIG. 5 is a flowchart of a method for generating an emotion cause pair based on conversation according to an embodiment of the present disclosure.

Hereinafter, the method will be described as an example of the apparatus 1000 for generating an emotion cause pair illustrated in FIG. 1.

Referring to FIG. 5, in step S5100, the apparatus 1000 for generating an emotion cause pair may receive utterance data which is information on conversations of multiple speakers.

In an embodiment, the utterance data may include information (e.g., identification information, age, gender, etc.) on multiple speakers, a plurality of utterance texts (e.g., sentences, words, etc.), utterance order information (e.g., temporal order between the utterance texts, etc.), etc.

In step S5200, the apparatus 1000 for generating an emotion cause pair may classify the utterance data into any one of several emotions according to a preset emotion classification system. Here, the emotion utterance text may refer to the utterance data that includes text representing an emotion of a specific emotion type (e.g., sadness, joy, anger, etc.) rather than a neutral emotion (no emotion) of the speaker or another speaker. In addition, the cause utterance text may refer to utterance data including text that is a cause causing the specific emotion type (e.g., sadness, joy, anger, etc.) of the speaker or another speaker. In an embodiment, the apparatus 1000 for generating an emotion cause pair may tokenize a plurality of utterance texts, respectively, based on a tokenizer to generate token sequences. The apparatus 1000 for generating an emotion cause pair may perform the token sequence representation from the plurality of tokenized utterance texts, that is, the token sequence, based on the BERT model. The apparatus 1000 for generating an emotion cause pair may classify the token sequence representations of each of the plurality of utterance texts into any one of the emotion utterance texts for the specific emotion type based on the emotion classification model such as the feed-forward neural network (FFNN), thereby classifying the plurality of utterance texts into either the emotion utterance text or non-emotion utterance text.

In an embodiment, the apparatus 1000 for generating an emotion cause pair may generate the utterance representations for each utterance text based on the information and token sequence expression of the speaker as a result of classifying the emotion utterance text for the plurality of utterance texts.

In step S5300, the apparatus 1000 for generating an emotion cause pair may generate the candidate emotion cause pair composed of the arbitrary emotion utterance text and the arbitrary cause utterance text.

In an embodiment, the apparatus 1000 for generating an emotion cause pair may generate the plurality of candidate emotion cause pairs composed of the utterance representation of the arbitrary utterance text classified into the emotion utterance text and the utterance representation within a certain number of times of utterances in the emotion utterance text. For example, when the number of utterance texts corresponding to the emotion utterance text is N (integers greater than or equal to 1) and the range of the number of times of utterances to be selected as the cause utterance text candidate is M, the apparatus 1000 for generating an emotion cause pair may generate up to N×M candidate emotion cause pairs.

In an embodiment, the apparatus 1000 for generating an emotion cause pair may generate the candidate emotion cause pair based on the utterance order information. For example, the apparatus 1000 for generating an emotion cause pair may match the arbitrary emotion utterance text with the arbitrary cause utterance text to generate the candidate emotion cause pair, and match the past arbitrary cause utterance text within a preset number of times of utterances with the arbitrary emotion utterance text based on the utterance order information of the arbitrary emotion utterance text to generate the emotion cause pair. This is because the utterance that is the cause of the specific emotion is usually made in the present or in the temporally close past.

In step S5400, the apparatus 1000 for generating an emotion cause pair may determine the emotion cause pair (hereinafter, actual emotion cause pair) composed of the actual emotion and the utterance text that is the cause of the emotion among the plurality of candidate emotion cause pairs to generate the emotion cause pair.

In an embodiment, the apparatus 1000 for generating an emotion cause pair may determine the actual emotion cause pair among the plurality of candidate emotion cause pairs based on the mix-of-experts (MOE) technique. Specifically, in order to apply the mixture-of-experts (MOE) technique, the apparatus 1000 for generating an emotion cause pair may include a plurality of expert models each predicting the actual emotion cause pair for different specific emotions, and a gating network that determines the weights for the prediction results of the emotion types of each of the plurality of expert models. In this case, the apparatus for generating a cause pair may input one candidate emotion cause pair to each of the plurality of expert models, and determine whether the corresponding candidate emotion cause pair is the actual emotion cause pair of any emotion cause pair type based on the plurality of prediction results and the weights determined by the gating network. Thereafter, the apparatus 1000 for generating an emotion cause pair may determine whether other candidate emotion cause pairs are the actual emotion cause pair of any emotion cause pair type through the same process.

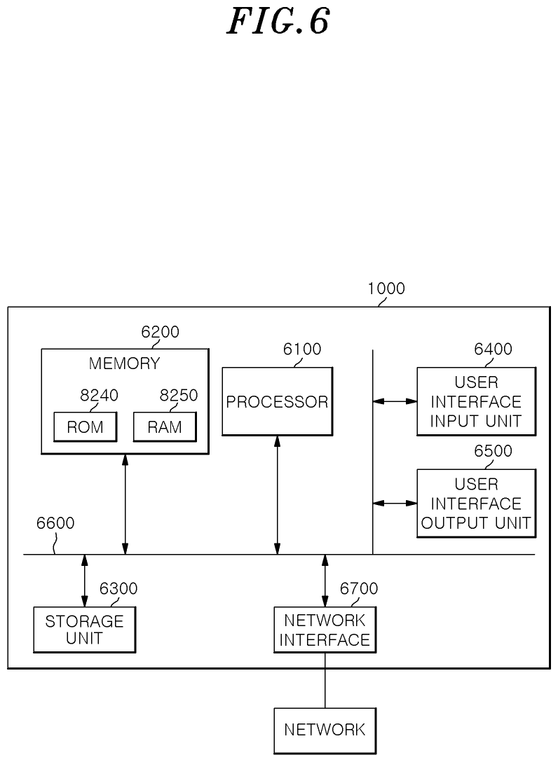

FIG. 6 is a block diagram of an apparatus 1000 for generating an emotion cause pair according to another embodiment of the present disclosure.

As illustrated in FIG. 6, the apparatus 1000 for generating an emotion cause pair includes at least one of a processor 6100, a memory 6200, a storage unit 6300, a user interface input unit 6400, and a user interface output unit 6500, which may communicate with each other via bus 6600. In addition, the apparatus 1000 for generating an emotion cause pair may also include a network interface 6700 for connecting to a network. The processor 6100 may be a central processing unit (CPU) or a semiconductor element executing processing commands stored in the memory 6200 and/or the storage unit 6300. The memory 6200 and the storage unit 6300 may include various types of volatile/non-volatile storage media. For example, the memory may include a read only memory (ROM) 6240 and a random access memory (RAM) 6250.

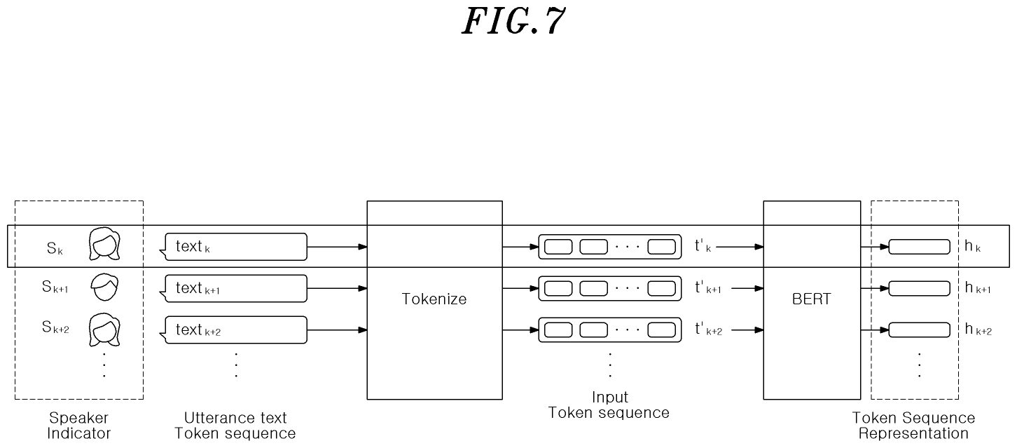

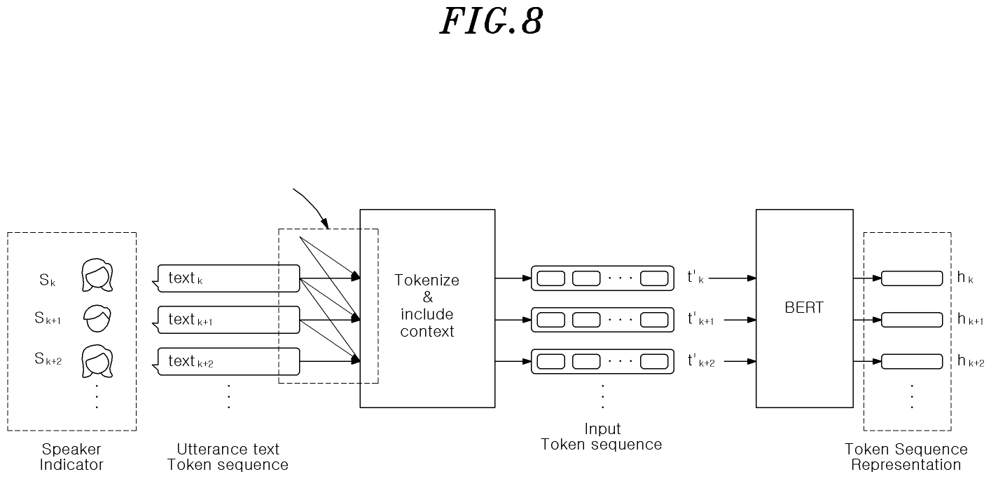

FIGS. 7 and 8 are diagrams for describing an example of tokenizing utterance text.

Referring to FIG. 7, an example of generating token sequence representations hₖ, hₖ₊₁, and hₖ₊₂ by individually tokenizing utterance texts textₖ, textₖ₊₁, and textₖ₊₂ which are conversations of each speaker, is illustrated.

Referring to FIG. 8, in tokenizing the utterance texts textₖ, textₖ₊₁, and textₖ₊₂, which are the conversations of each speaker, an example of tokenizing the utterance texts, further including the previous utterance text, when tokenizing each utterance text is illustrated. That is, in the process of tokenizing the utterance text textₖ₊₁, the tokenization may be performed, further including the previous utterance text textₖ, and in the process of tokenizing the utterance text textₖ₊₂, the tokenization may be performed, further including the previous utterance texts textₖ₊₁ or textₖ and textₖ₊₁.

The tokenization method according to FIG. 8 performs the tokenization by referring to the previous utterance texts, and thus, can generate the token sequence representation that reflects the understanding of the context, making it possible to further improve the performance of the emotion classification.

Various embodiments of this document can be implemented as software (e.g., a program) containing instructions stored on machine-readable storage media (e.g., memory, either internal or external). The machine, such as a computer, can retrieve the stored instructions from the storage media and operate according to the retrieved instructions. The machine can include an electronic device according to the disclosed embodiments. When the instructions are executed by the control unit, the control unit can perform the functions corresponding to the instructions either directly or by using other components under its control. The instructions can include code generated or executed by a compiler or an interpreter. The machine-readable storage media can be provided in the form of non-transitory storage media. Here, non-transitory means that the storage media does not include signals and is tangible, but does not distinguish whether the data is stored permanently or temporarily on the storage media.

According to an embodiment, the methods according to the various embodiments disclosed in this document can be provided in a computer program product.

In one embodiment, a computer-readable recording medium storing a computer program includes instructions for a processor to perform operations comprising: receiving image data of a patient's medical record, converting the image data of the medical record into text data, extracting item data from the text data, evaluating the reliability of the extracted item data, and providing patient information for the extracted item data if the evaluated reliability exceeds a threshold.

In another embodiment, a computer program stored on a computer-readable recording medium includes instructions for a processor to perform operations comprising: receiving image data of a patient's medical record, converting the image data of the medical record into text data, extracting item data from the text data, evaluating the reliability of the extracted item data, and providing patient information for the extracted item data if the evaluated reliability exceeds a threshold.

Although the embodiments have been described with reference to the drawings and examples, it will be understood by those skilled in the art that various modifications and changes can be made within the technical idea of the embodiments described in the following claims.

What is claimed is:

1. A method for generating an emotion cause pair based on conversation performed by an apparatus using an emotion cause pair prediction model, the method comprising:
receiving a plurality of utterance texts converted from a voice conversation between a plurality of speakers;
classifying each of the plurality of utterance texts for each emotion and detecting at least one of emotion utterance texts among the plurality of utterance texts;
generating candidate emotion cause pairs each including a pair of an emotion utterance text selected from among the at least one of the emotion utterance texts and a cause utterance text corresponding to the selected emotion utterance text; and
determining the emotion cause pair from the plurality of generated candidate emotion cause pairs.

2. The method of claim 1, wherein the receiving the plurality of utterance texts includes receiving utterance order information of the plurality of utterance texts, and
wherein the generating the candidate emotion cause pairs includes determining the cause utterance text of the selected emotion utterance text corresponding to a present or past utterance text within a preset number of times of utterances based on the utterance order information.

3. The method of claim 1, wherein the receiving includes receiving information of the plurality of speakers corresponding to each utterance text, and
wherein the generating the emotion cause pair includes determining an emotion cause pair type based on information of each speaker and an emotion type of each speaker, and generating the emotion cause pair based on the emotion cause pair type.

4. The method of claim 3, wherein the generating the emotion cause pair includes determining at least one true emotion cause pair based on a mix-of-experts (MOE) technique using a gating network and a plurality of expert models.

5. The method of claim 4, wherein each expert model is a model pre-trained to predict the true emotion cause pair corresponding to each emotion cause pair type, and
wherein the gating network is configured to determine a weight for a prediction result of each expert model.

6. The method of claim 5, wherein the generating the emotion cause pair includes:
inputting a first candidate emotion cause pair among the candidate emotion cause pairs into each expert model, and
determining whether the first candidate emotion cause pair is a true emotion cause pair corresponding to any of the emotion cause pair types based on the prediction result of each expert model and the weight.

7. The method of claim 1, wherein the detecting the at least one of the emotion utterance texts includes vectorizing each utterance text including a previous utterance text based on a natural language processing model, and classifying each vectorized utterance text into at least one of several emotion based on an emotion classification model.

8. The method of claim 7, wherein the detecting the at least one of the emotion utterance texts includes generating a token sequence from the plurality of utterance texts based on a tokenizer and generating a token sequence representation from the token sequence based on BERT to generate each utterance text.

9. The method of claim 1, wherein the detecting the at least one of the emotion utterance texts includes classifying the utterance text as at least one of emotion type among a plurality of emotion types.

10. The method of claim 1, wherein the generating the plurality of candidate emotion cause pairs includes generating the candidate emotion cause pair including the selected emotion utterance text corresponding to the same emotion type among the plurality of emotion types and a present or past cause utterance text within the set number of times of utterances in the at least one of the emotion utterance texts.

11. A device for generating an emotion cause pair based on conversation, the device comprising:
a memory configured to store by an emotion cause pair prediction model and one or more instructions for preforming the emotion cause pair prediction model; and
a processor configured to execute the one or more instructions stored in the memory, wherein the instructions, when executed by the processor, cause the processor to:
receive a plurality of utterance texts converted from a voice conversation between a plurality of speakers;
classify each of the plurality of utterance texts for each emotion and detect at least one of emotion utterance texts among the plurality of utterance texts;
generate candidate emotion cause pairs each including a pair of an emotion utterance text selected from among the at least one of the emotion utterance text texts and a cause utterance text corresponding to the selected emotion utterance text; and
determine the emotion cause pair from the plurality of generated candidate emotion cause pairs.

12. The device of claim 11, wherein the processor is configured to receive utterance order information of the plurality of utterance texts, and determine the cause utterance text of the selected emotion utterance text corresponding to a present or past utterance text within a preset number of times of utterances based on the utterance order information.

13. The device of claim 11, wherein the processor is configured to receive information of the plurality of speakers corresponding to each utterance text, and determine an emotion cause pair type based on information of each speaker and an emotion type of each speaker, and generating the emotion cause pair based on the emotion cause pair type.

14. The device of claim 11, wherein the processor is configured to determine at least one true emotion cause pair based on a mix-of-experts (MOE) technique using a gating network and a plurality of expert models.

15. The device of claim 14, wherein each expert model is a model pre-trained to predict the true emotion cause pair corresponding to each emotion cause pair type, and
wherein the gating network is configured to determine a weight for a prediction result of each expert model.

16. The device of claim 15, wherein the processor is configured to input a first candidate emotion cause pair among the candidate emotion cause pairs into each expert model, and determine whether the first candidate emotion cause pair is a true emotion cause pair corresponding to any of the emotion cause pair types based on the prediction result of each expert model and the weight.

17. The device of claim 11, wherein the processor is configured to vectorize each utterance text including a previous utterance text based on a natural language processing model, and classifying each vectorized utterance text into at least one of several emotion based on an emotion classification model.

18. The device of claim 17, wherein the processor is configured to generate a token sequence from the plurality of utterance texts based on a tokenizer, and generate a token sequence representation from the token sequence based on BERT to generate each utterance text.

19. The device of claim 11, wherein the processor is configured to generate the candidate emotion cause pair including the selected emotion utterance text corresponding to the same emotion type among the plurality of emotion types and the cause utterance text.

20. A non-transitory computer readable storage medium storing computer executable instructions, wherein the instructions, when executed by a processor, cause the processor to perform a method for generating an emotion cause pair based on conversation, the method comprising:
receiving a plurality of utterance texts converted from a voice conversation between a plurality of speakers;
classifying each of the plurality of utterance texts for each emotion and detecting at least one of emotion utterance texts among the plurality of utterance texts;
generating candidate emotion cause pairs each including a pair of an emotion utterance text selected from among the at least one of the emotion utterance texts and a cause utterance text corresponding to the selected emotion utterance text; and
determining the emotion cause pair from the plurality of generated candidate emotion cause pairs.
